(19) United States
(12) Patent Application Publication
(10) Pub. No.: US 2026/0264179 A1
(43) Pub. Date: Sep. 10, 2026

(54) UNIVERSAL WELDING ALIGNMENT SYSTEM FOR RING-SHAPED PARTS

(71) Applicant: TWB COMPANY, LLC, Monroe, MI (US)

(72) Inventors: Isaac LUTHER, Waterford, MI (US); Wayne HUISMAN, Carleton, MI (US)

(73) Assignee: TWB COMPANY, LLC, Monroe, MI (US)

(21) Appl. No.: 19/560,814

(22) Filed: Mar. 9, 2026

Related U.S. Application Data
(60) Provisional application No. 63/769,285, filed on Mar. 10, 2025.

(51) Int. Cl. B23K 37/053

(52) U.S. Cl. CPC B23K 37/053

(57) ABSTRACT

A welding alignment system for ring-shaped parts is provided and includes first and second alignment clamps and a lifting device. The first alignment clamp can receive and support a first blank, and the second alignment clamp can receive and support a second blank for joining the first blank and the second blank by welding. The lifting device can lift one or more blanks that have already been welded to the first and second blanks to reduce a gap between the first blank and the second blanks at the first and second alignment clamps.

### RELATED APPLICATIONS

The present application claims the benefit of U.S. Provisional Application No. 63/769,285 filed on March 10, 2025, which is herein incorporated by reference in its entirety.

### TECHNICAL FIELD

In general, the present invention relates to a welding alignment system for ring-shaped parts made from at least two blanks that can be used for a variety of ring-shaped part designs.

### BACKGROUND OF THE INVENTION

Ring-shaped parts, such as door rings in the automotive industry, are formed by welding a variety of blanks together to ultimately form a single ring-shaped part. By using a variety of precut blanks to form the ring-shaped part, the ring-shaped part can comprise a variety of materials and/or material thicknesses to achieve desired mechanical properties for crash energy management. Custom, costly alignment fixtures are used to form a particular ring-shaped part such that each blank can be aligned with one another prior to welding each blank together. After welding, the flat, ring-shaped part is pressed into a desired shape such as a door frame for a vehicle.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates some embodiments of a single alignment fixture and lifting device for a universal welding alignment system as described herein.

FIG. 2A and 2B illustrate some embodiments of the universal welding alignment system as described herein comprising adjustment mechanisms and an alignment sensor system.

FIG. 3 illustrates some embodiments of the universal welding alignment system that has received a first blank A and a second blank B for alignment and welding.

FIGS. 4A, 4B, 4C, 5A, and 5B illustrate how the first blank A and the second blank B may be aligned on the adjustment mechanism as identified by the alignment sensor system of the universal welding alignment system.

FIGS. 6, 7, 8, 9 and 10 illustrate an iterative welding method of welding multiple blanks to one another to form a ring-shaped part, one weld seam at a time, using the universal welding alignment system as described herein.

FIG. 11 illustrates a flowchart of an exemplary method of welding multiple blanks to one another to form a ring-shaped part, one weld seam at a time, using the universal welding alignment system as described herein.

### DETAILED DESCRIPTION OF THE INVENTION

Embodiments of the invention relate to methods and systems that relate to a universal welding alignment system for welding several blanks together to form a single ring-shaped part. The universal welding alignment system can be used to weld blanks together in a variety of industries, including the automotive industry, aerospace industry, construction industry, and other manufacturing industries. Non-limiting examples of ring-shaped parts in the automotive industry, for example, include single door rings, double door rings, engine cradles, roof rings, and battery rings. The precut blanks used to form the ring-shaped parts typically require strict specifications with low tolerances so that when the final two blanks are ready to be welded, there is not a large gap between the final two blanks that is so large and/or misaligned that the two blanks cannot be reliably welded. An unwanted, large gap can also occur if the blanks are misaligned with one another throughout the welding process. Typically, if such a large gap were present when welding the last seam, the entire part may be discarded as waste.

The universal welding alignment system presented herein comprises a single alignment fixture configured to receive two blanks, a transport system configured to transport blanks to be welded onto the single alignment fixture, an alignment sensor system configured to analyze the alignment of the two blanks at the single alignment fixture, a welding device configured to weld the two blanks once aligned, and a lifting device configured to lift one or more blanks that have already been welded to adjust alignment and/or close a gap, if present, between two blanks arranged at the single alignment fixture for welding the final weld seam to form the single, ring-shaped part. With only a single alignment fixture, the universal welding alignment system successively aligns and welds each part. This iterative welding process allows the universal welding alignment system to focus on a single weld seam at a time such that the universal welding alignment system can be used on any kind of ring-shaped part design, thereby avoiding the need for custom alignment fixtures for every iteration of a ring-shaped part design. Additionally, the iterative welding process allows for adjustment throughout the alignment and welding process to accommodate for any blank that may be out of specification or have an inherent process variation.

By adjusting the alignment process as the welding progresses, the final weld that ultimately closes the loop to form the ring-shaped part is less likely to have a large gap that would scrap the part. If there is a gap or edge offset detected by the alignment sensor system at the final seam, the lifting device of the universal welding alignment system can be activated to vertically lift an area of the ring-shaped part that has already been welded such that the gap is sufficiently reduced and/or eliminated and the final weld can be reliably performed. When the lifting device is utilized, the ring-shaped part may be elastically deformed such that the ring-shaped part is not completely flat along a horizontal plane. In other embodiments, even when the lifting device is utilized, the ring-shaped part is completely flat along a horizontal plane after welding, as the weight of the ring-shaped part may flatten any such elastic deformations. The ring-shaped part may then be further processed via hot stamping, cold stamping, or the like. During the stamping, any stresses in the elastically deformed areas are relaxed such that the final stamped part still meets specifications.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

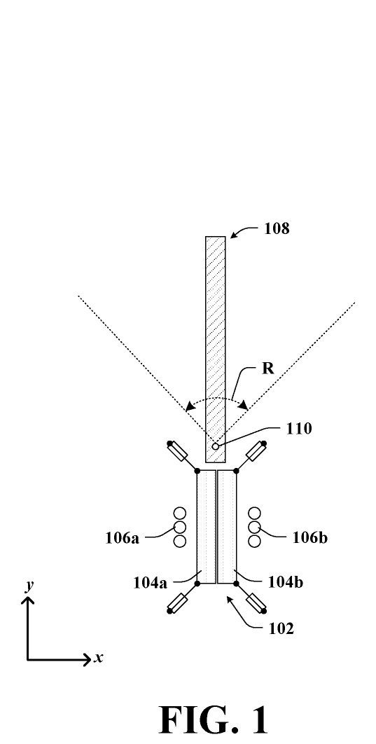

Turning now to FIG. 1, an exemplary universal alignment system is illustrated. The universal alignment system at least includes a single alignment fixture 102 comprising a first clamp 104a and a second clamp 104b. The first and second clamps 104a, 104b are each configured to receive a blank, where the blank on the first clamp 104a faces the blank on the second clamp 104b for welding the blanks to one another. In some embodiments, the first clamp 104a and the second clamp 104b comprise magnets integrated therein for securing the blanks onto the clamps 104a, 104b. In some other embodiments, the first and second clamps 104a, 104b may securing blanks via a vacuum, suction cup, electrostatic, or mechanical clamping means. The single alignment fixture 102 may further include peripheral magnets 106a, 106b adjacent the first and second clamps 104a, 104b for further securing of the blanks to the clamps 104a, 104b during alignment and welding. The first clamp 104a and corresponding first peripheral magnets 106a are responsible for moving a first blank secured thereon, while the second clamp 104a and corresponding second peripheral magnets 106a are responsible for moving a second blank secured thereon.

Each of the first and second clamps 104a, 104b may be rotatable around the z-axis (the z-axis being into/out of page in FIG. 1). Thus, each of the first and second clamps 104a, 104b are movable along the x-axis and/or the y-axis and have two-dimensional movement only. Such movements of the first and second clamps 104a, 104b allow the universal welding alignment system to adjust the blanks on the clamps 104a, 104b relative to one another in a suitable position for welding. In some other embodiments, the first and second clamps 104a, 104b are rotated and/or movable about any of the x-axis, y-axis, and/or z-axis. In some such other embodiments, the first and second clamps 104a, 104b (and thus, any blank arranged thereon) may have three-dimensional movement.

The universal alignment system further includes a lifting device 108, which can be an elongated component configured to lift one or more blanks that have already been welded in a z-direction (into/out of the page). To achieve the “lifting” motion, the lifting device 108 may be vertically movable along the z-axis or be rotated about the x-axis. The lifting device 108 may also pivot about a pivoting pin 110 to rotate about the z-axis as shown by angle R in FIG. 1 and thus, also can move along the xy-plane. Thus, in some embodiments, the lifting device 108 has three-dimensional movement, while the first and second clamps 104a, 104b are configured to only move two-dimensionally on the xy-plane. In some other embodiments, the universal welding alignment system comprises more than one lifting device 108 to provide several points of lift along the z-axis for an even more tunable alignment of a final weld gap. The lifting device 108 is not limited to a bar shaped device configured to receive a blank and contact/support an underside of the blank, as shown in FIG. 1. In some other embodiments, the lifting device 108 may be arranged above the blanks and contact a topside of the blank to move the blank along the z-direction.

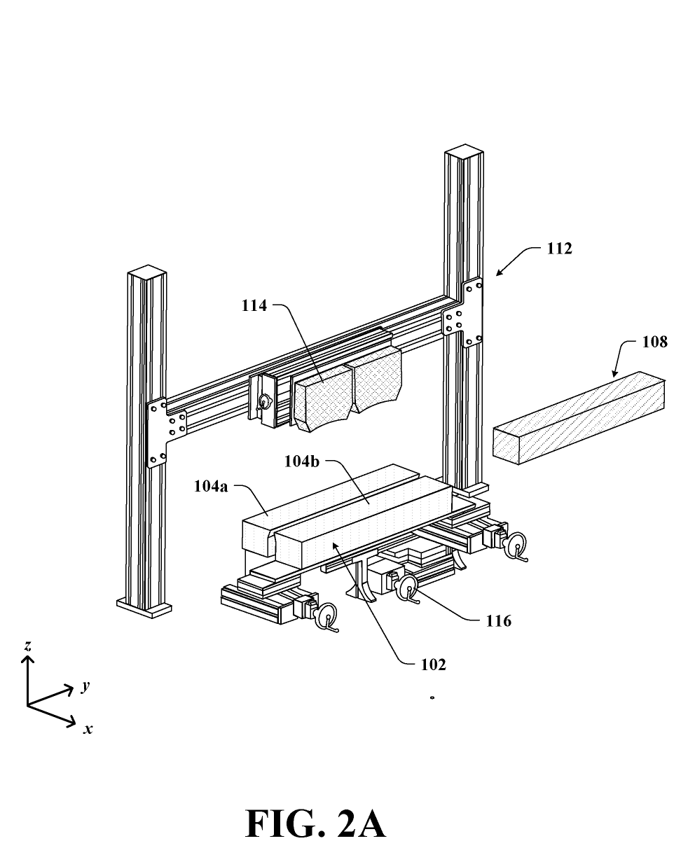

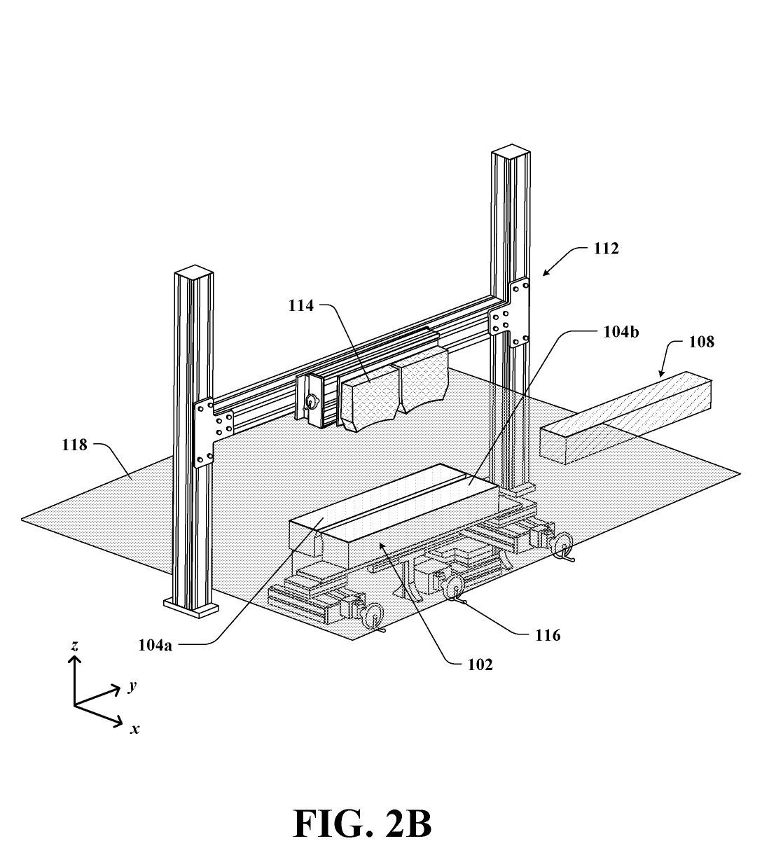

Turning additionally to FIG. 2A, more components of the universal welding alignment system are shown. For example, the single alignment fixture 102 may be coupled to adjustment mechanisms 116 configured to provide the first and second clamp 104a, 104b movement at least along the xy-plane, as described in FIG. 1. Topmost surfaces of the first and second clamps 104a, 104b may be substantially coplanar such that the clamps 104a, 104b do not need to be moved in along the z-axis. The universal alignment system further includes an alignment sensor system 112. The alignment sensor system 112 can comprise one or more sensors 114 directed at the single alignment fixture 102 and is configured to analyze the alignment of the two blanks received at the single alignment fixture 102. As will be described further herein, the alignment sensor system 112 can determine gaps, edge offsets, and the like between the two blanks. The sensors 114 can comprise cameras, lasers, or some other suitable technology configured to take measurements of the blanks on the alignment sensor system 112. For example, the sensors 114 may be 3D structured light sensors. The alignment sensor system 112 can include a support fixture that allows the sensors 114 to move in the x, y, and/or z directions to take reliable measurements of the blanks on the alignment sensor system 112. The alignment sensor system 112 may be calibrated to define a coordinate system with respect to the single alignment fixture 102 such that the alignment sensor system 112 can detect when the blanks are placed on the single alignment fixture 102 and at what position on the single alignment fixture 102.

The alignment sensor system 112 may comprise or be connected to a processor/computer configured to collect alignment measurements according to preset instructions, determine the degree of misalignment, and communicate with processors/computers in the single alignment fixture 102 and the lifting device 108 to move the single alignment fixture 102 and/or the lifting device 108 as desired to achieve more suitable alignment between the blanks for welding. The tolerance of misalignment, degree of movement required by the single alignment fixture 102 and the lifting device 108, and the like may be predetermined and stored in the processor. The process of the alignment sensor system 112 may take multiple measurements and repeat measurements overtime to ensure the suitable alignment has been achieved before providing instructions to a welding device to proceed with welding the two blanks secured on the single alignment fixture 102. Each of the components in the alignment sensor system 112 and the adjustment mechanisms 116 of single alignment fixture 102 (including adjustment mechanisms of the lifting device 108) are automated and may be in communication with one another or with a central control processor via wired or wireless connections to repeatedly sense and adjust the position of blanks arranged on the single alignment fixture 102 to a desired alignment. The desired alignment of each blank with respect to another blank may be predetermined such that the alignment sensor system 112 and the single alignment fixture 102 can automatically perform the alignment process.

Turning additionally to FIG. 2B, an xy-plane 118 is illustrated, where the topmost surfaces of the first and second clamps 104a, 104b are substantially coplanar with the xy-plane 118. At rest, a topmost surface of the lifting device 108 is also substantially coplanar with the xy-plane 118. The universal welding alignment system is configured to support the blanks on the xy-plane 118. Thus, the system further includes a welding table, multiple support structures, or some other suitable structure that is arranged on the xy-plane 118 and nearby the clamps 104a, 104b and the lifting device 108 to provide further support for blanks arranged and overhanging the clamps 104a, 104b and the lifting device 108. Throughout most of the welding process, the blanks are intended to stay flat on the xy-plane 118. As will be described in more detail later, if there is a gap present at the last seam prior to welding, the lifting device 108 may move in the z-direction to break the blanks out of the xy-plane 118 to close or at least reduce the gap between the blanks at the single alignment fixture 102 for the final weld seam step.

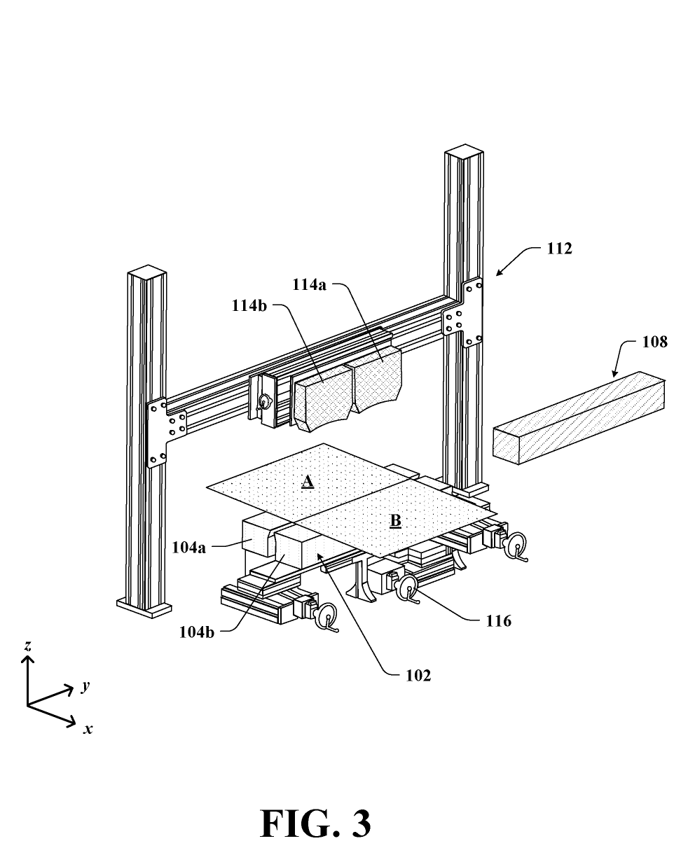

Turning additionally to FIG. 3, the universal welding alignment system further comprises transport system (not illustrated) configured to move blanks on the single alignment fixture 102. For example, a transport system (e.g., robot arm, suction cup system, etc.) can move blank A on the first clamp 104a and blank B on the second clamp 104b. It will be appreciated that portions of the blanks A, B that are not supported by the clamps 104a, 104b in FIG. 3 would be supported by some table, support structures, or the like on the xy-plane 118 as shown in FIG. 2B.

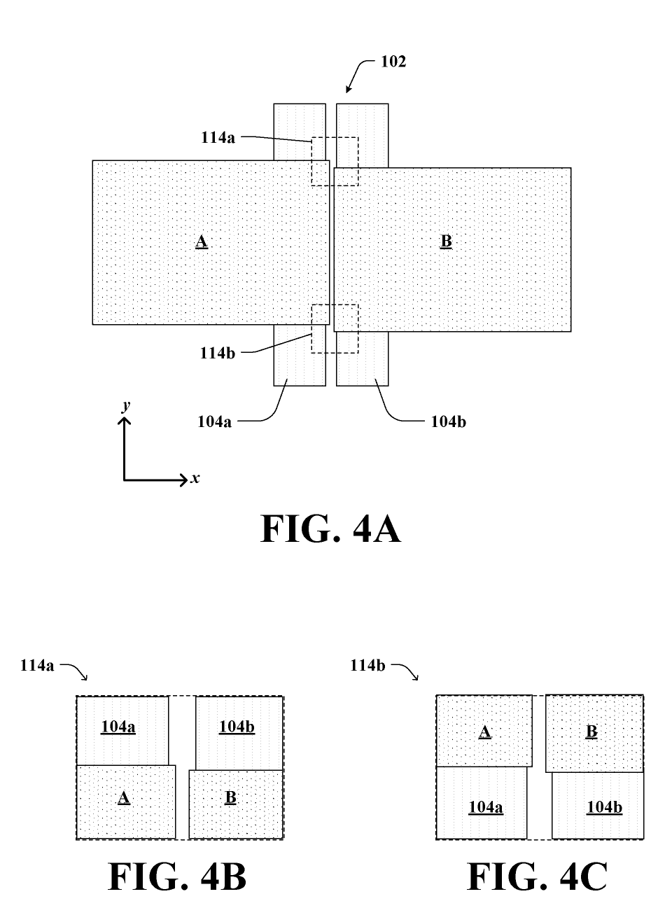

FIG. 4A illustrates a simplified top-view of blank A and blank B on the single alignment fixture 102. In FIG. 4A, dotted boxes are used to show the area of the clamps 104a, 104b and blanks A, B that are viewed by the first and second sensors 114a, 114b. In some embodiments, the first sensor 114a is configured to capture the orientation of the blanks A, B on the clamps 104a, 104b at a first edge of the blanks A, B, while the second sensor 114b is configured to capture the orientation of the blanks A, B on the clamps 104a, 104b at a second edge of the blanks A, B opposite to the first edge along the y-axis.

FIGS. 4B and 4C illustrate magnified schematics of such orientations as captured by the respective first and second sensors 114a, 114b. FIG. 4B shows that the first sensor 114a is directed towards a first corner of the first blank A that is adjacent a first corner of the second blank B. FIG. 4C shows that the second sensor 114b is directed towards a second corner of the first blank B that is adjacent a second corner of the second blank B.

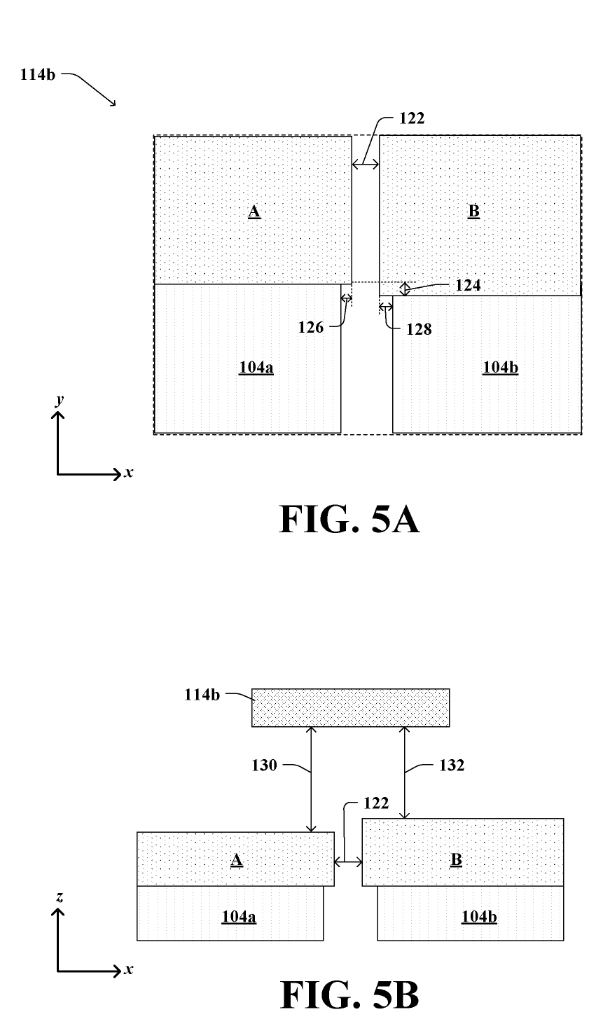

FIG. 5A provides a magnified view of the second sensor 114b view from FIG. 4C. To perform a measurement with one of the sensors 114a, 114b, the sensors 114a, 114b, the clamps 104a, 104b, and the magnets (e.g., integrated with 104a, 104b and/or peripheral to 104a, 104b) are moved to a known, predetermined location. Then the sensors 114a, 114b can determine whether the blanks A, B arranged on the clamps 104a, 104b and the magnets are at an expected aligned location or are at unexpected, misaligned location. For example, in FIG. 5A, the blanks A, B are misaligned.

As shown in FIG. 5A, the second sensor 114b is configured to measure a gap distance 122 along the x-axis between opposing, inner edges of blank A and blank B to be welded to one another; a lower edge distance 124 along the y-axis between bottom edges of blank A and blank B; a first inner edge distance 126 along the x-axis between the inner edge of blank A to be welded and the first clamp 104a; and a second inner edge distance 128 along the x-axis between the inner edge of blank B to be welded and the second clamp 104b. When both sensors measure the gap distance 122, variations in the gap distance 122 along the length of the gap in the y-direction can be determined. For example, several measurements of the gap distance 122 at different points along the y-axis can determine whether the blanks A, B are arranged at an undesired angle with respect to one another on the xy-plane.

As shown in FIG. 5B, the sensors 114a, 114b may also measure the thickness of each blank A and blank B by measuring the distance between the sensors 114a, 114b and the surfaces of the blanks A, B arranged closest to the sensors 114a, 114b. The blanks A, B may intentionally have different thicknesses for different strength requirements. For example, in FIG. 5B, a first height distance 130 is measured along the z-axis between the second sensor 114b and a topmost surface of blank A; and a second height distance 132 is measurement along the z-axis between the second sensor 114b and a topmost surface of blank B. Because topmost surfaces of the first and second clamps 104a, 104b are substantially coplanar, bottommost surfaces of the blanks A, B should also be substantially coplanar. Thus, the distance between a bottommost surface of the blanks A, B and the second sensor 114b is known and is equal to the distance between the topmost surface of each clamp 104a, 104b and the second sensor 114b. Together, the known distance from the bottommost surfaces of each blank A, B and the first and second height distances 130, 132 can indicate a thickness of each blank A, B as well as a difference in thickness between each blank A and blank B. When welding is performed, the bottommost surfaces of the blanks A, B are substantially coplanar with one another on the xy-plane. Thus, the first and second clamps 104a, 104b may not move along the z-axis as to not disrupt their substantial coplanar topmost surface arrangement.

The aforementioned measurements on the xy-plane from FIG. 5A (e.g., 122, 124, 126, 128) may be utilized by the processor to determine how much each of the clamps 104a, 104b should move to provide better alignment. “Better alignment” can depend on the tolerances specified for a particular ring-shaped part. It can be assumed that “better alignment” is when each of the distances 124, 126, 128 are reduced from their starting point. In some other embodiments, overlap of the blanks A, B may be desired; in some such other embodiments, at least distance 122 is measured and the blanks A, B are adjusted such that there is sufficient overlap for welding.

Only a single alignment fixture 102 is needed because only a single intended weld seam area (e.g., weld at the opposing inner edges of blanks A and B in FIG. 3) is aligned at one time. By only relying on alignment of one seam at a time, the universal welding alignment system can adjust and compensate for any minor misalignment or off-spec blanks as the welding process continues, which ultimately reduces the size of a gap and/or misalignment between blanks at the final weld seam step.

Once the alignment sensor system 112 indicates that blank A and blank B are sufficiently aligned, a welding device is activated such that the opposing, inner edges of blank A and blank B are welded. The welding device may utilize various types of welding, such as laser welding, electron beam welding, arc welding, friction welding, and other suitable methods. In some embodiments, just prior to the welding process, a surface preparation step may be performed to prepare the inner edges of the blanks A, B for welding. Such surface preparation steps include ablation processes, chemical cleaning, or the like. In other embodiments, the preparation steps may be performed prior to the blanks A, B being loaded onto the single alignment fixture 102.

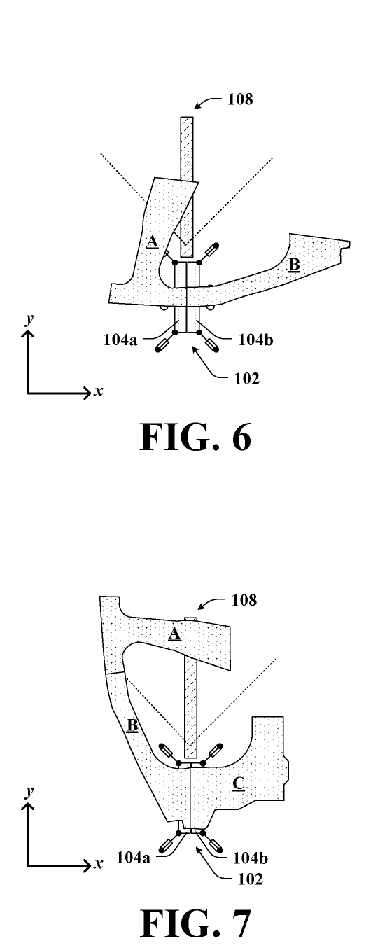

Turning additionally to FIGS. 6-10, a method of performing the iterative alignment and welding process using the disclosed universal welding alignment system is shown. The universal welding alignment system can be used to produce a variety of ring-shaped parts made from two or more blanks. The universal welding alignment system is not only much more cost-effective than acquiring custom alignment fixtures for each desired ring-shaped part but it also has a smaller footprint than such custom alignment fixtures. Additionally, the universal welding alignment system, particularly the single alignment fixture 102 and the lifting device 108, may be implemented into an already established welding assembly line with alignment devices/sensors, welding devices, and transport systems.

As shown in FIG. 6, blank A and blank B are loaded onto the single alignment fixture 102 by a transport system. The transport system can have its own positioning system to position the blanks A, B on their respective magnets/clamps of the single alignment fixture 102. Once positioned by the transport system, the blanks A, B are secured to the fixture 102 by magnets or some other securing means. While the transport system can generally align the blanks A, B onto the single alignment fixture 102, The alignment process, utilizing the alignment sensor system 112 and the movement of the first and second clamps 104a, 104b, is performed, and the blank A is welded to blank B at the single alignment fixture 102.

As shown in FIG. 7, the welded blanks A and B are moved by the transport system to align blank B on the first clamp 104a. The transport system can then load a new blank C for welding on the second clamp 104b. Again, the alignment process is performed with respect to the opposing inner edges of blanks B and C, and the opposing inner edges of blanks B and C are welded at the single alignment fixture 102. Blank B is now welded to both blank A and blank C. It will be appreciated that at FIG. 7, instead of welding blank C to blank B, a different blank may instead be aligned and welded to blank A. Thus, the exact order of which blanks are aligned and welded to one another in FIGS. 6-9 may vary.

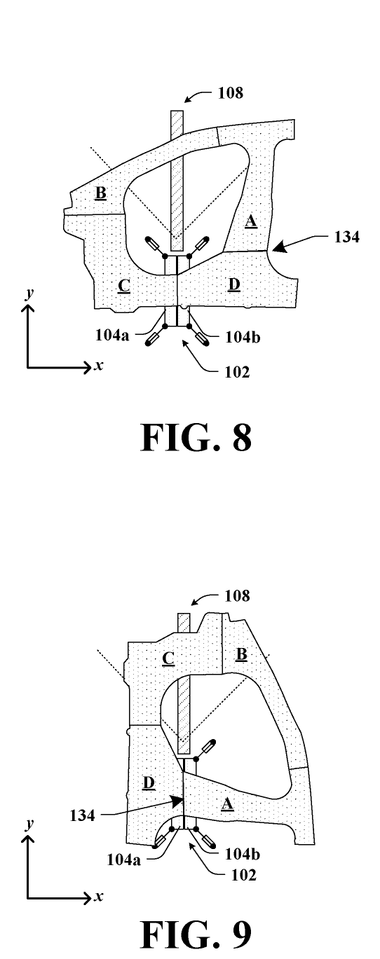

As shown in FIG. 8, the welded blanks A, B, and C are moved by the transport system to align blank C on the first clamp 104a. The transport system can then load a new blank D for welding on the second clamp 104b. In this example, blank D is the last blank needed to form the ring-shaped part. Blank D needs to be welded to blank A and to blank C. In FIG. 8, the alignment process is first performed with respect to the opposing inner edges of blanks C and D, and the opposing inner edges of blanks C and D are welded at the single alignment fixture 102. Because the universal welding alignment system is designed to focus on one weld seam at a time in an iterative process, alignment between blanks A and D is not monitored while the opposing inner edges of blanks C and D are aligned and welded at the single alignment fixture 102. The remaining seam to be welded is notated with arrow 134 in FIG. 8, which could be a gap or misalignment between blanks A and D.

As shown in FIG. 9, the welded blanks A, B, C, and D are moved by the transport system to align blank D on the first clamp 104a and to align blank A at the second clamp 104b such that the final gap 134 is at the single alignment fixture 102. In FIG. 9, blank C is supported by the lifting device 108. The lifting device 108 is first utilized for the alignment step of the final gap 134. When the alignment sensor system 112 determines the severity of the final gap 134, the alignment sensor system 112 can determine the suitable placement of the lifting device 108 on the xy-plane and the suitable amount that the lifting device 108 should move in the z-direction to essentially bend portions of the blanks that have already been welded. Such a “bend” provided by the lifting device 108 reduces the distance of the final gap 134 in the x- and y-directions. In some embodiments, the lifting device 108 does not comprise securing devices (e.g., magnets, clamps, etc.) such that the blanks can easily bend upon the movement of the lifting device 108 to provide slack to the final gap 134. The location of the “vertical lift” provided by the lifting device 108 is not supported by the single alignment fixture 102. In some embodiments, the “vertical lift” location is on a blank that has already been welded or at least is closer to a weld than the final unwelded gap 134.

In some embodiments, even with the lifting device 108 in use, the single alignment fixture 102 may still apply force to the blanks A and D to move the blanks A and D in the x- and y-directions to best align the blanks and close the final gap 134. To reduce stress on the blanks, force is applied in the x- and y-directions via the single alignment fixture 102 after the lifting device 108 has moved in the z-direction. Because of the lifting device 108, that force necessary to close the final gap 134 in the x- and y-directions by the single alignment fixture 102 is reduced. In some embodiments, the force may be reduced by over 50% because of the bend provided by the lifting device 108. Reductions in this final joining force reduces stress in the final ring-shaped part while also reducing risk of the final blanks A and D from slipping from the magnets within the clamps 104a, 104b during welding. The final joining force to weld the final gap 134 should be less than the maximum shear force of the clamps 104a, 104b to prevent such slippage. Once the final gap 134 is at a suitable tolerance, the final gap 134 is welded, thereby forming a single ring-shaped part.

Because of the z-axis movement by the lifting device 108 out of the xy-plane 118, neither the upper nor the lower surface of the single-ring shaped part is coplanar with the xy-plane 118 during the final weld. The single-ring shaped part may then be removed from the universal welding alignment system and hot stamped into a more 3D part. Any stresses in the single-ring shaped part can be relaxed when the ring-shaped part is heated and hot stamped into its finally formed 3D part.

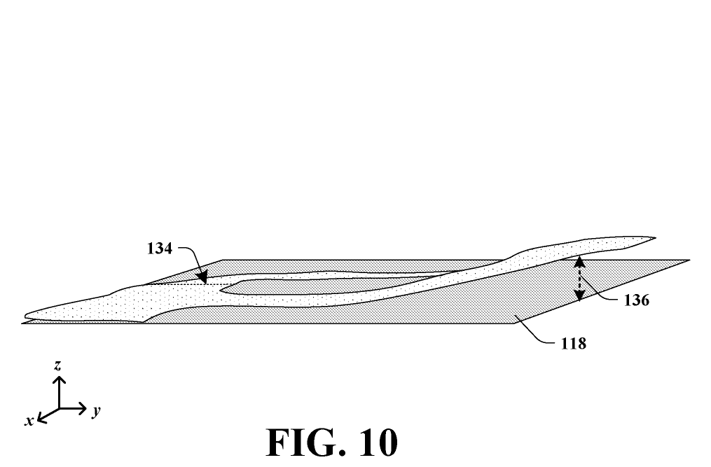

FIG. 10 illustrates a perspective view of the single-ring shaped part at its final weld step described in FIG. 9. For simplicity, only the blanks and the xy-plane 118 are illustrated in FIG. 10. As seen in FIG. 10, a substantial portion of the blanks near the final weld gap 134 are still coplanar with the xy-plane. The lifting device 108 raises a portion of the ring-shaped part that has already been welded and is away from the single alignment fixture 102. The lifting device 108 may raise the portion of the ring-shaped part by at most a distance 136 in the z-direction to provide sufficient “bend” in surrounding areas of the ring-shaped part, which ultimately reduces the gap 134 at the final weld seam. The alignment sensor system 112 and the lifting device 108 may be in communication to ensure the distance 136 and location of the lift by the lifting device 108 is sufficient before confirming that the final gap 134 is suitable for welding. In some embodiments, the distance 136 is in a range of between, for example, about 10mm and about 1000mm or more preferably between, for example, about 50mm and about 200mm. The distance 136 may be, in some embodiments, greater than a maximum thickness of the ring-shaped part. In some embodiments, the activated lifting device 108 can allow the final gap 134 to reduce by a distance between 1mm and 5mm in the x-direction. Thus, what otherwise may be considered as an intolerable final gap distance (e.g., greater than 1mm) can be closed due to the lifting device 108 and waste of the final part is avoided.

The direction of the weld can also influence the distance defining the final gap 134. Alternating the direction of the weld at each alignment and welding step can aid in reduction of the distance defining the final gap 134. For example, at FIG. 6, the weld may be made in the positive y-direction. Then, at FIG. 7, the weld may be made in the negative y-direction; at FIG. 8, the weld may be made in the positive y-direction; and at FIG. 9, the weld may be made in the negative y-direction. The alternating weld directions balances any process variation (e.g., distortion from thermal expansion during welding) on the blanks throughout the ring-shaped part, which ultimately reduces misalignment at the final gap 134.

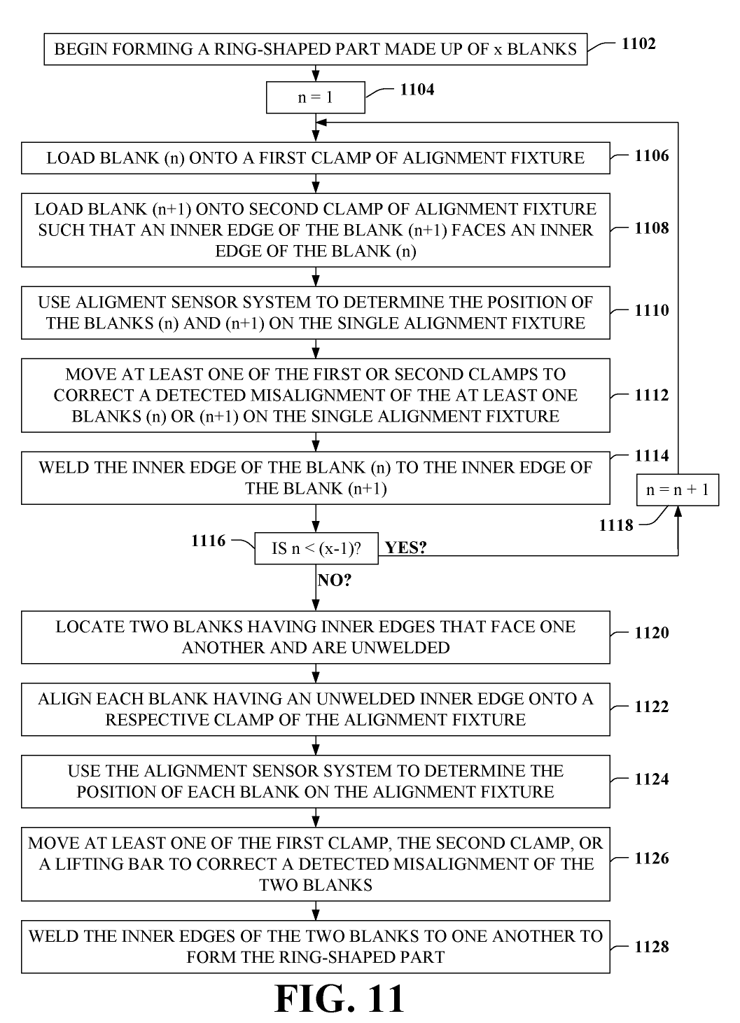

Turning now to FIG. 11, a flow chart of the exemplary method of performing the iterative alignment and welding process using the disclosed universal welding alignment system is shown. The flow chart of FIG. 11 may correspond to the steps shown in FIGS. 6-9.

At step 1102, the forming of a ring-shaped part made up of x blanks begins. At step 1104, n =1. At step 1106, blank (n) is loaded onto a first clamp of the alignment fixture. At step 1108, blank (n+1) is loaded onto a second clamp of the alignment fixture such that an inner edge of the blank (n+1) faces an inner edge of the blank (n). As an example, FIG. 6 may correspond to steps 1106 and 1108.

At step 1110, an alignment sensor system is used to determine the position of the blanks (n) and (n+1) on the single alignment fixture. At step 1112, at least one of the first or second clamps are moved to correct a detected misalignment of the at least one blanks (n) or (n+1) on the single alignment fixture. At step 1114, the inner edge of the blank (n) is welded to the inner edge of the blank (n+1).

At step 1116, steps 1106 to 1114 are repeated if n is less than (x-1). If n is less than (x-1), then step 1118 indicates that the process repeats at step 1106, where n now equals 2. The steps of 1106 to 1116 continue until n is greater than or equal to (x-1).

For example, if a ring-shaped part is made up of 4 blanks, such as the part shown in FIGS. 6-9, then x is equal to 4. When n equals 1, steps 1104 to 1114 correspond to FIG. 6, where blank A is aligned and welded to blank B. Then, at step 1118, n increases to 2. When n equals 2, steps 1106 to 1114 correspond to FIG. 7, where blank B is aligned and welded to blank C. Then, at step 1118, n increases to 3. When equals 3, steps 1106 to 1114 correspond to FIG. 8, where blank C is aligned and welded to blank D. At step 1116, n (which now equals 3) is no longer less than (x-1), where x is equal to 4. Therefore, the method proceeds to step 1120.

At step 1120, there are two blanks that have inner edges that face one another and are unwelded. In FIG. 8, blanks A and D correspond to the two blanks of step 1120, where gap 134 is arranged therebetween.

At step 1122, each blank having an unwelded edge is aligned onto a respective clamp of the alignment fixture. Step 1122 may correspond to FIG. 9, where blank D is aligned on the first clamp 104a and blank A is aligned on the second clamp 104b.

At step 1124, the alignment sensor system is used to determine the position of each blank on the alignment fixture. At step 1126, at least one of the first clamp, the second clamp, or a lifting bar are moved to correct a detected misalignment of the two blanks. Movement of the lifting bar, if necessary, at step 1126 is illustrated in FIG. 10, as an example.

At step 1128, the inner edges of the two blanks are welded to one another to form the ring-shaped part.

It will be appreciated that one or more steps in the method of FIG. 11 may be modified slightly while still performing a seam-by-seam welding process utilizing the disclosed universal welding alignment system. For example, which blank gets loaded onto which clamp may vary at steps 1106 and 1108.

The following are non-limiting examples of some embodiments of the present disclosure:

Embodiment 1. A welding alignment system for ring-shaped parts comprising:

a first alignment clamp configured to receive a first blank;

a second alignment clamp arranged adjacent the first alignment clamp and configured to receive a second blank for joining the first blank to the second blank by welding; and

a lifting device configured to lift one or more blanks that have already been welded to the first and second blanks to adjust a gap between the first blank and the second blank at the first and second alignment clamps.

Embodiment 2. The welding alignment system of Embodiment 1, wherein the first alignment clamp and the second alignment clamp are configured to move two-dimensionally along an xy-plane.

Embodiment 3. The welding alignment system of Embodiment 2, wherein the first alignment clamp and the second alignment clamp are configured to only move two-dimensionally along the xy-plane.

Embodiment 4. The welding alignment system of any one of Embodiments 1 to 3, wherein the lifting device is configured to move in a z-direction, normal to the xy-plane.

Embodiment 5. The welding alignment system of any one of Embodiments 1 to 4, wherein the first and second alignment clamps are configured to move two-dimensionally, and wherein the lifting device is configured to move three-dimensionally.

Embodiment 6. The welding alignment system of any one of Embodiments 1 to 5, wherein each of the first and second alignment clamps comprise magnets configured to hold the first and second blanks onto the first and second alignment clamps.

Embodiment 7. The welding alignment system of any one of Embodiments 1 to 6, further comprising an alignment sensor system arranged above the first and second alignment clamps.

Embodiment 8. The welding alignment system of Embodiment 7, wherein the alignment sensor system comprises a first sensor and a second sensor, each sensor being configured to determine the position of each blank on each respective clamp.

Embodiment 9. A welding alignment system for ring-shaped parts comprising:

a single alignment fixture configured to receive a first blank and a second blank and move along an xy-plane;

a lifting device configured to move in a z-direction normal to the xy-plane; and

an alignment sensor system arranged above the single alignment fixture and configured to collect data on the position of the first and second blanks on the single alignment fixture.

Embodiment 10. The welding alignment system of Embodiment 9, wherein the lifting device is also configured to move in the x-direction and the y-direction.

Embodiment 11. The welding alignment system of Embodiment 9 or 10, further comprising a support table configured to support several blanks on the xy-plane, the support table surrounding the single alignment fixture and the lifting device.

Embodiment 12. The welding alignment system of Embodiment 11, wherein uppermost surfaces of the support table, the single alignment fixture, and the lifting device that are configured to contact the first and second blanks are substantially coplanar with one another on the xy-plane.

Embodiment 13. The welding alignment system of any one of Embodiments 9 to 12, wherein the alignment sensor system is configured to communicate with the single alignment fixture and the lifting device to better align the first and second blanks for welding.

Embodiment 14. The welding alignment system of any one of Embodiments 9 to 13, further comprising a welding device configured to weld the first blank to the second blank at the single alignment fixture.

Embodiment 15. The welding alignment system of any one of Embodiments 9 to 14, further comprising a transport system configured to load the first and second blanks onto the single alignment fixture.

Embodiment 16. The welding alignment system of any one of Embodiments 9 to 15, wherein the single alignment fixture cannot move in the z-direction.

Embodiment 17. The welding alignment system of any one of Embodiments 9 to 16, wherein the single alignment fixture comprises magnets to secure the first and second blanks to the single alignment fixture.

Embodiment 18. A method of welding two or more blanks together to form a ring-shaped part, the method comprising:

loading a first blank onto a first clamp of a single alignment fixture;

loading a second blank onto a second clamp of the single alignment fixture, the first blank comprising a first inner edge facing a second inner edge of the second blank;

using an alignment sensor system to determine the position of the first and second blanks on the single alignment fixture;

determining that at least one of the first or second blanks are misaligned on the single alignment fixture based on the positions identified by the alignment sensor system;

moving at least one of the first or second clamps along an xy-plane to correct the misalignment of the at least one first or second blank on the single alignment fixture; and

welding the first inner edge to the second inner edge.

Embodiment 19. The method of Embodiment 18, wherein after the first and second blanks are arranged on the first and second clamps, respectively, the first blank, the second blank, or a third blank welded to the first or second blank is arranged on a lifting device, the lifting device being movable in a z-direction.

Embodiment 20. The method of Embodiment 19, wherein after determining that at least one of the first or second blanks are misaligned on the single alignment fixture, moving the lifting device in a z-direction before welding the first inner edge to the second inner edge.

The aforementioned systems, components, (e.g., single alignment fixture, lifting device, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur – this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A welding alignment system for ring-shaped parts comprising:
a first alignment clamp configured to receive a first blank;
a second alignment clamp arranged adjacent the first alignment clamp and configured to receive a second blank for joining the first blank to the second blank by welding; and
a lifting device configured to lift one or more blanks that have already been welded to the first and second blanks to adjust a gap between the first blank and the second blank at the first and second alignment clamps.

2. The welding alignment system of claim 1, wherein the first alignment clamp and the second alignment clamp are configured to move two-dimensionally along an xy-plane.

3. The welding alignment system of claim 2, wherein the first alignment clamp and the second alignment clamp are configured to only move two-dimensionally along the xy-plane.

4. The welding alignment system of claim 2, wherein the lifting device is configured to move in a z-direction, normal to the xy-plane.

5. The welding alignment system of claim 1, wherein the first and second alignment clamps are configured to move two-dimensionally, and wherein the lifting device is configured to move three-dimensionally.

6. The welding alignment system of claim 1, wherein each of the first and second alignment clamps comprise magnets configured to hold the first and second blanks onto the first and second alignment clamps.

7. The welding alignment system of claim 1, further comprising an alignment sensor system arranged above the first and second alignment clamps.

8. The welding alignment system of claim 7, wherein the alignment sensor system comprises a first sensor and a second sensor, each sensor being configured to determine the position of each blank on each respective clamp.

9. A welding alignment system for ring-shaped parts comprising:
a single alignment fixture configured to receive a first blank and a second blank and move along an xy-plane;
a lifting device configured to move in a z-direction normal to the xy-plane; and
an alignment sensor system arranged above the single alignment fixture and configured to collect data on the position of the first and second blanks on the single alignment fixture.

10. The welding alignment system of claim 9, wherein the lifting device is also configured to move in the x-direction and the y-direction.

11. The welding alignment system of claim 9, further comprising a support table configured to support several blanks on the xy-plane, the support table surrounding the single alignment fixture and the lifting device.

12. The welding alignment system of claim 11, wherein uppermost surfaces of the support table, the single alignment fixture, and the lifting device that are configured to contact the first and second blanks are substantially coplanar with one another on the xy-plane.

13. The welding alignment system of claim 9, wherein the alignment sensor system is configured to communicate with the single alignment fixture and the lifting device to better align the first and second blanks for welding.

14. The welding alignment system of claim 9, further comprising a welding device configured to weld the first blank to the second blank at the single alignment fixture.

15. The welding alignment system of claim 9, further comprising a transport system configured to load the first and second blanks onto the single alignment fixture.

16. The welding alignment system of claim 9, wherein the single alignment fixture cannot move in the z-direction.

17. The welding alignment system of claim 9, wherein the single alignment fixture comprises magnets to secure the first and second blanks to the single alignment fixture.

18. A method of welding two or more blanks together to form a ring-shaped part, the method comprising:
loading a first blank onto a first clamp of a single alignment fixture;
loading a second blank onto a second clamp of the single alignment fixture, the first blank comprising a first inner edge facing a second inner edge of the second blank;
using an alignment sensor system to determine the position of the first and second blanks on the single alignment fixture;
determining that at least one of the first or second blanks are misaligned on the single alignment fixture based on the positions identified by the alignment sensor system;
moving at least one of the first or second clamps along an xy-plane to correct the misalignment of the at least one first or second blank on the single alignment fixture; and
welding the first inner edge to the second inner edge.

19. The method of claim 18, wherein after the first and second blanks are arranged on the first and second clamps, respectively, the first blank, the second blank, or a third blank welded to the first or second blank is arranged on a lifting device, the lifting device being movable in a z-direction.

20. The method of claim 19, wherein after determining that at least one of the first or second blanks are misaligned on the single alignment fixture, moving the lifting device in a z-direction before welding the first inner edge to the second inner edge.
